(19) United States
(12) Patent Application Publication
(10) Pub. No.: US 2026/0274031 A1
(43) Pub. Date: Sep. 17, 2026

(54) SUSPENSION CONTROL APPARATUS AND VEHICLE

(71) Applicant: SUBARU CORPORATION, Tokyo (JP)

(72) Inventor: Tsutomu TAKESHITA, Tokyo (JP)

(21) Appl. No.: 19/552,832

(22) Filed: Feb. 27, 2026

(30) Foreign Application Priority Data
Mar. 12, 2025 (JP) 2025-038976

(51) Int. Cl. B60G 17/0165

(52) U.S. Cl. CPC B60G 17/0165; B60G 2400/82; B60G 2400/90

(57) ABSTRACT

A suspension control apparatus is configured to be applied to a vehicle and switch damping force characteristics of a damper in an electronically controlled suspension. The suspension control apparatus includes a memory and a control device. The memory is configured to store following-vehicle data from an in-vehicle sensor that measures a distance between a following vehicle rushing from behind and the vehicle. The control device is configured to: determine, based on the following-vehicle data stored in the memory, whether a rear-end collision between the following vehicle and the vehicle is to occur; and, when determining that the rear-end collision is to occur, perform a process of increasing a damping force of a rear damper disposed on a rear-wheel side of the vehicle compared with a damping force of a front damper disposed on a front-wheel side of the vehicle.

### CROSS-REFERENCE TO RELATED APPLICATIONS

The present application claims priority from Japanese Patent Application No. 2025-038976 filed on Mar. 12, 2025, the entire contents of which are hereby incorporated by reference.

### BACKGROUND

The disclosure relates to a suspension control apparatus to be installed in a vehicle, such as an automobile, and a vehicle including the suspension control apparatus.

A suspension device is installed in a vehicle, for example, to maintain grip between tires and a road surface and to absorb shocks from the road surface. In recent years, as such a suspension device, an electronically controlled suspension has been developed. The electronically controlled suspension is capable of actively adjusting a damping force in a shock absorber.

As described above, the electronically controlled suspension can vary the damping force of the shock absorber at any point in time and thus can be used, for example, for shock absorption during a collision. In this respect, in a suspension control apparatus disclosed in Japanese Unexamined Patent Application Publication (JP-A) No. 2021-98410, it is proposed to harden damping force characteristics of a damping force adjustable shock absorber for a front or rear part of a vehicle when information on the possibility of a collision between the front or rear part of the vehicle and a projection on a road surface in a direction of travel of the vehicle is input.

The electronically controlled suspension can suppress changes in the attitude of a vehicle during a collision. In this respect, in a vehicle collision damage reduction apparatus disclosed in JP-A No. 2004-345427, collision prediction information is generated by predicting that a vehicle is to collide with an object. In accordance with the collision prediction information, a vehicle height adjustment device is controlled to lower a vehicle height.

### SUMMARY

An aspect of the disclosure provides a suspension control apparatus configured to be applied to a vehicle and switch damping force characteristics of a damper in an electronically controlled suspension. The suspension control apparatus includes a memory and a control device. The memory is configured to store following-vehicle data from an in-vehicle sensor configured to measure a distance between a following vehicle rushing from behind and the vehicle. The control device is configured to: determine, based on the following-vehicle data stored in the memory, whether a rear-end collision between the following vehicle and the vehicle is to occur; and, when determining that the rear-end collision is to occur, perform a process of increasing a damping force of a rear damper disposed on a rear-wheel side of the vehicle compared with a damping force of a front damper disposed on a front-wheel side of the vehicle.

An aspect of the disclosure provides a vehicle including the in-vehicle sensor and the suspension control apparatus.

An aspect of the disclosure provides a suspension control apparatus configured to be applied to a vehicle and switch damping force characteristics of a damper in an electronically controlled suspension. The suspension control apparatus includes a memory and circuitry. The memory is configured to store following-vehicle data from an in-vehicle sensor configured to measure a distance between a following vehicle rushing from behind and the vehicle. The circuitry is configured to: determine, based on the following-vehicle data stored in the memory, whether a rear-end collision between the following vehicle and the vehicle is to occur; and, when determining that the rear-end collision is to occur, perform a process of increasing a damping force of a rear damper disposed on a rear-wheel side of the vehicle compared with a damping force of a front damper disposed on a front-wheel side of the vehicle.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating an example configuration of a vehicle according to an embodiment of the disclosure;

FIG. 2 is a schematic diagram illustrating a state of the vehicle and a following vehicle before a rear-end collision;

FIG. 3 is a schematic diagram illustrating an example configuration of a suspension control apparatus and its peripheral devices to be installed in the vehicle according to the embodiment;

FIG. 4 is a schematic diagram illustrating an example of damping force adjustment for electronically controlled suspensions during a rear-end collision;

FIG. 5 is a schematic diagram illustrating an example of damping force adjustment for the electronically controlled suspensions during a rear-end collision in consideration of a road surface condition;

FIG. 6 is a flowchart illustrating a suspension control method during a rear-end collision according to the embodiment;

FIG. 7 is a schematic diagram illustrating an example configuration of the suspension control apparatus and its peripheral devices to be installed in the vehicle according to an embodiment;

FIG. 8 is a schematic diagram illustrating an example of damping force adjustment for the electronically controlled suspensions during a rear-end collision in consideration of a collision part (high/low) of the following vehicle;

FIG. 9 is a flowchart illustrating a suspension control method during a rear-end collision according to the embodiment; and

FIG. 10 is a schematic diagram illustrating an example of damping force adjustment for the electronically controlled suspensions during a rear-end collision in consideration of a collision part (left/right) in a vehicle width direction with the following vehicle.

### DETAILED DESCRIPTION

According to JP-A Nos. 2021-98410 and 2004-345427 described above, when a vehicle collides with an object, the damping force of a suspension can be adjusted to provide some degree of shock absorption. However, when the vehicle is hit by a following vehicle (hereinafter, a collision pattern in which the vehicle is rear-ended by a following vehicle is also referred to as “rear-end collision”), different vehicle behaviors may occur at the moment of and immediately after the collision. Regarding this, in the related art including JP-A Nos. 2021-98410 and 2004-345427 described above, issues concerning damping force adjustment including vehicle behaviors not only at the moment of a rear-end collision but also immediately after the rear-end collision have not been recognized. There is much room for improvement of damping force adjustment for the suspension during a rear-end collision.

It is desirable to provide a suspension control apparatus and a vehicle that enable a more stable vehicle behavior during a rear-end collision.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### First Embodiment

Note that configurations other than those described in detail below may be complemented as appropriate by known elemental technology and configurations regarding vehicles including JP-A Nos. 2021-98410 and 2004-345427 described above.

### <Vehicle 200>

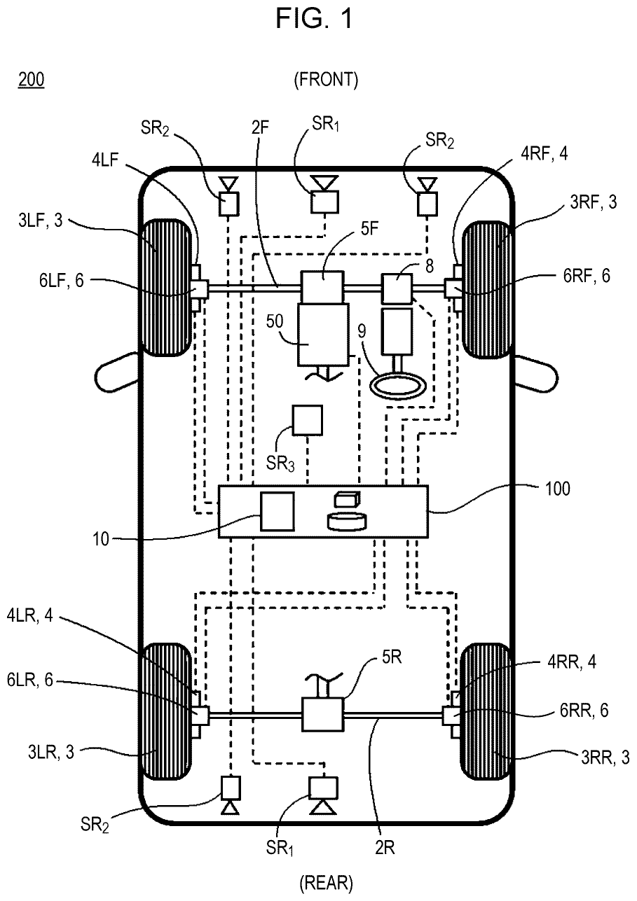

FIG. 1 is a schematic diagram illustrating an example configuration of a vehicle 200 according to this embodiment. The vehicle 200 illustrated in FIG. 1 is a four-wheel-drive vehicle in which driving torque output from a driving force source 50 that generates driving torque of the vehicle is transmitted to all wheels via a transmission (not illustrated), a front-wheel differential mechanism 5F, and a rear-wheel differential mechanism 5R. Driving torque output from the driving force source 50 is transmitted to a left front wheel 3LF, a right front wheel 3RF, a left rear wheel 3LR, and a right rear wheel 3RR (hereinafter, collectively referred to as “wheels 3” when not particularly distinguished from each other) via a front-wheel drive shaft 2F and a rear-wheel drive shaft 2R.

The driving force source 50 may be an internal-combustion engine, such as a gasoline engine or diesel engine, may be a drive motor, or may include both an internal-combustion engine and a drive motor. The vehicle 200 may be an electric vehicle including, for example, two drive motors, which are a front-wheel drive motor and a rear-wheel drive motor, or may be an electric vehicle including drive motors corresponding to the respective wheels 3. Furthermore, when the vehicle 200 is an electric vehicle or hybrid electric vehicle, the vehicle 200 includes, for example, a known secondary battery, a known generator, or a known converter.

The vehicle 200 includes, as equipment used for controlling driving of the vehicle, for example, a known electric steering system 8, and known brake devices 4LF, 4RF, 4LR, and 4RR (hereinafter, collectively referred to as “brake devices 4” when not particularly distinguished from each other) in addition to the above-described driving force source 50. In this embodiment, the above-described electric steering system 8 is provided at the front-wheel drive shaft 2F. The electric steering system 8 according to this embodiment can adjust steering angles of the left front wheel 3LF and the right front wheel 3RF. The electric steering system 8 includes a known motor and gears (not illustrated) for driving its electric steering and is controlled based on a steering angle of a steering wheel 9 by a driver who drives the vehicle 200, for example.

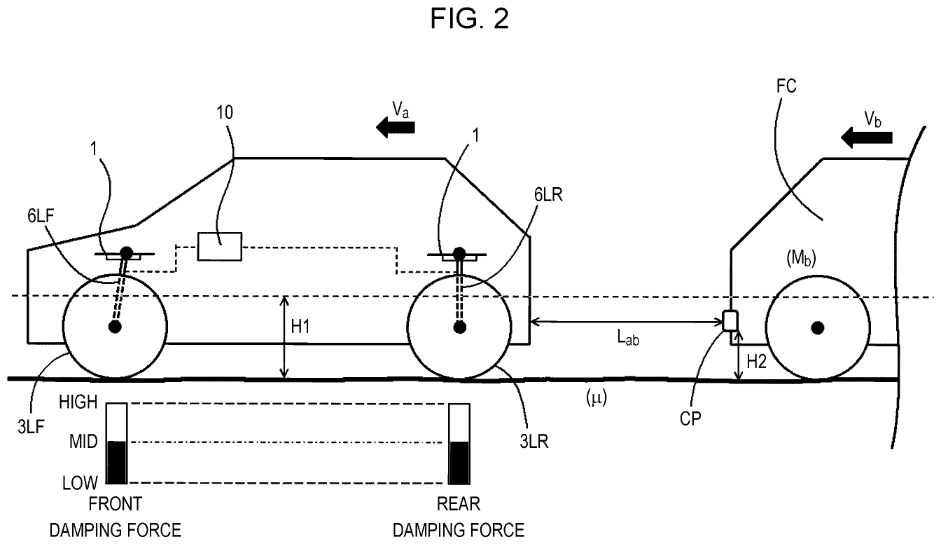

As illustrated in FIG. 2, the vehicle 200 according to this embodiment includes electronically controlled suspensions 6 provided between a vehicle body 1 and the wheels 3. The electronically controlled suspensions 6 according to this embodiment correspond to the respective wheels and include a left front electronically controlled suspension 6LF corresponding to the left front wheel 3LF, a right front electronically controlled suspension 6RF corresponding to the right front wheel 3RF, a left rear electronically controlled suspension 6LR corresponding to the left rear wheel 3LR, and a right rear electronically controlled suspension 6RR corresponding to the right rear wheel 3RR. In one example, as for the configuration of the electronically controlled suspensions 6, various known electronically controlled suspensions illustrated, for example, in JP-A No. 2002-283822 and others may be used.

The electronically controlled suspensions 6 according to this embodiment are configured so that a damping force of each damper can be adjusted for the respective wheels. For example, as illustrated in FIG. 2, a suspension control apparatus 100 to be described later can set the damping force of the dampers in the electronically controlled suspensions (6LF and 6RF) on a front-wheel side to a middle (Mid) setting and can also set the damping force of the dampers in the electronically controlled suspensions (6LR and 6RR) on a rear-wheel side to a middle (Mid) setting. Note that the suspension control apparatus 100 can set different values of the damping force of the dampers for the electronically controlled suspensions on the front-wheel side and the electronically controlled suspensions on the rear-wheel side.

As illustrated in FIG. 1, the vehicle 200 according to this embodiment includes in-vehicle sensors SR. The in-vehicle sensors SR according to this embodiment include image capturing sensors SR₁, distance measuring sensors SR₂, and a vehicle state sensor SR₃, for example.

The image capturing sensors SR₁ include, for example, a known forward capturing camera and a known rear capturing camera that are illustrated. The forward capturing camera has a function of capturing an image of an area in front of the vehicle 200 and can generate image data including, for example, a road surface of a lane in which the vehicle 200 travels. The rear capturing camera has a function of capturing an image of an area behind the vehicle 200 and can generate image data including, for example, a following vehicle FC traveling behind the vehicle 200 as illustrated in FIG. 2.

Such forward capturing and rear capturing cameras include, for example, a known charge-coupled device (CCD) or complementary metal-oxide-semiconductor (CMOS) imaging element and transmit generated image data to a control device 10 to be described later. In the vehicle 200 illustrated in FIG. 1, although each of the forward capturing and rear capturing cameras is illustrated as a monocular camera, one or more of the forward capturing and rear capturing cameras may be a stereo camera including, for example, a pair of left and right imaging elements.

The distance measuring sensors SR₂ are a known distance measuring sensor capable of measuring a distance between the vehicle 200 and an object. Such distance measuring sensors SR₂ may be, for example, a known light detection and ranging (LiDAR) system, but may also be a known radar sensor, such as a millimeter-wave radar capable of measuring a distance, or a known ultrasonic sensor. As illustrated in FIG. 1, the distance measuring sensors SR₂ according to this embodiment are provided in front and rear respective areas of the vehicle 200. The distance measuring sensors SR₂ provided in the front area can measure a distance to an object (for example, a preceding vehicle or obstacle) present in front of the vehicle 200, for example. On the other hand, the distance measuring sensor SR₂ provided in the rear area can measure a distance to an object (for example, a following vehicle) present behind the vehicle 200, for example.

The vehicle state sensor SR₃ includes at least one sensor that detects a state of the vehicle 200. In one example, the vehicle state sensor SR₃ according to this embodiment includes, for example, a known yaw rate sensor capable of detecting a yaw rate of the vehicle 200, a known vehicle velocity sensor capable of detecting a velocity of the vehicle 200, and so forth. The vehicle state sensor SR₃ may further include, in addition to the above-described sensors, a known acceleration sensor, a known lateral acceleration sensor, a known angular velocity sensor, and a known global navigation satellite system (GNSS) sensor. A detection signal of the vehicle state sensor SR₃ is transmitted to the control device 10 to be described later.

The control device 10 may be one of one or more known electronic control units (ECUs). Furthermore, the control device 10 may be configured to be able to couple to a known external network NET, such as the Internet, for example, via a form of smartphone-mediated communication, or via various known communication devices CT, such as an in-vehicle communication device. A known communication device CT, the in-vehicle sensors SR to be described later, a memory MD to be described later, known notification devices PD (for example, a speaker SP and a display DP) to be described later, etc. are electrically coupled to the control device 10 directly or via an in-vehicle communication system, such as a controller area network (CAN) or local interconnect network (LIN).

### <Suspension Control Apparatus 100>

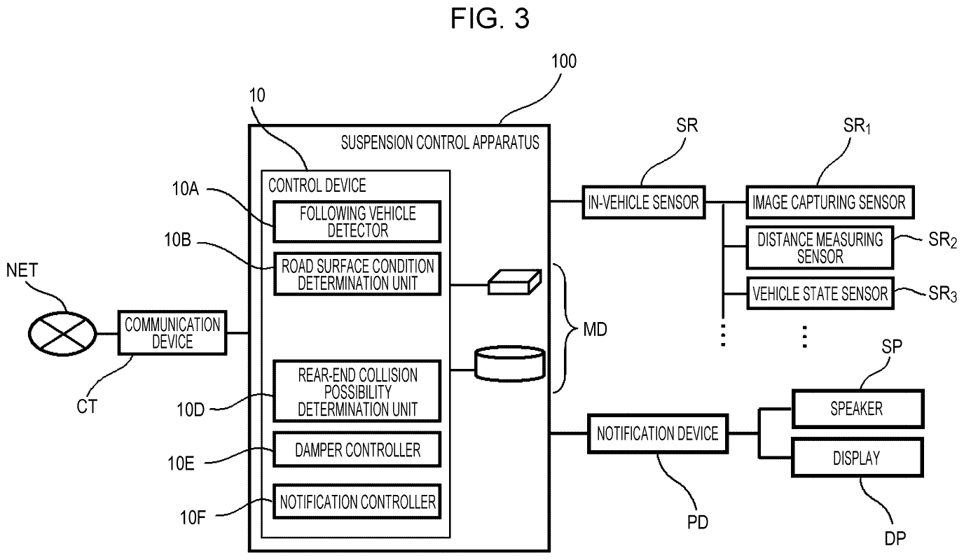

Next, the suspension control apparatus 100 will be described with reference to FIG. 3. The suspension control apparatus 100 according to this embodiment includes the above-described control device 10, and one or more memories MD communicably coupled to the control device 10. Examples of memories MD include, for instance, a known recording device, such as a hard disk or solid state drive (SSD), in addition to a known storage element, such as a random access memory (RAM), and a known flash memory, such as a Universal Serial Bus (USB) memory or SSD.

A configuration of the suspension control apparatus 100 when a following vehicle rear-ends the vehicle 200 that is travelling will be described below. As illustrated in FIG. 3 and others, the suspension control apparatus 100 according to this embodiment has a function of switching damping force characteristics of the dampers in the above-described electronically controlled suspensions 6. The suspension control apparatus 100 according to this embodiment includes the memory MD that stores following-vehicle data from the in-vehicle sensor SR that measures a distance between the following vehicle FC rushing from behind and the vehicle 200 (the preceding vehicle as seen from the following vehicle FC) and the control device 10 that determines, based on the following-vehicle data stored in the memory MD, whether a rear-end collision between the following vehicle FC and the vehicle 200 is to occur.

### <Functional Blocks of Control Device 10>

FIG. 3 illustrates an example configuration of the control device 10 included in the suspension control apparatus 100 according to this embodiment. As described later, when determining that a rear-end collision is to be caused by the following vehicle FC, the control device 10 according to this embodiment can perform a process of increasing values of the damping force of the dampers in the rear electronically controlled suspensions (6LR and 6RR) disposed on the rear-wheel side of the vehicle 200 compared with values of the damping force of the dampers in the front electronically controlled suspensions (6LF and 6RF) disposed on the front-wheel side of the vehicle 200.

As can be understood from FIG. 3, the control device 10 according to this embodiment includes, for example, a following vehicle detector 10A, a rear-end collision possibility determination unit 10D, a damper controller 10E, and a notification controller 10F.

### (Following Vehicle Detector 10A)

The following vehicle detector 10A has a function of detecting the following vehicle FC traveling behind the vehicle 200, for example, via the image capturing sensor SR₁ of the in-vehicle sensors SR. The following vehicle detector 10A may detect the following vehicle FC, for example, by using a technique disclosed in JP-A No. 2002-319091. The following vehicle detector 10A may detect the presence of the following vehicle FC, for example, by performing known vehicle-to-vehicle communication with the following vehicle FC in addition to detection of the following vehicle using the image capturing sensor SR₁.

### (Road Surface Condition Determination Unit 10B)

A road surface condition determination unit 10B has a function of detecting and determining a condition of a road surface on which the vehicle 200 travels, for example, via the image capturing sensors SR₁ of the in-vehicle sensors SR. The road surface condition determination unit 10B may detect a condition of the road surface (dry, wet, frozen, etc.) by using a known technique disclosed, for example, in JP-A No. 2024-034470 or JP-A No. 2023-039045. A result of a determination made by the road surface condition determination unit 10B can be stored in the above-described memory MD as road surface condition data (dry, wet, frozen, etc.). The road surface condition determination unit 10B may be optional in the control device 10 according to this embodiment and may be omitted as appropriate.

### (Rear-End Collision Possibility Determination Unit 10D)

The rear-end collision possibility determination unit 10D has a function of determining a possibility that the following vehicle FC detected by the following vehicle detector 10A is to collide with the vehicle 200. The rear-end collision possibility determination unit 10D can determine a rear-end collision possibility by using a technique described below as an example.

First, without considering an anti-lock braking system (ABS), assume that the braking distance when the following vehicle FC brakes fully is Lo, the distance between the rear end of the vehicle 200 and the following vehicle FC is L_{ab}, the velocity of the vehicle 200 is Vₐ, the velocity of the following vehicle FC is Vo, the coefficient of friction with the road surface is u, a vehicle weight of the following vehicle FC is Mb, and gravitational acceleration is g (see FIG. 2 and others as appropriate).

The coefficient of friction with the road surface described above can be set, for example, to μ=0.7 for a dry road, μ=0.5 for a wet road, and μ=0.1 for a frozen road. The above-described coefficients for the respective road surface conditions are examples, and the coefficient of friction with the road surface may be appropriately adjusted by using other known techniques. When a known sensor installed in the vehicle 200 can calculate the coefficient of friction with the road surface, the coefficient of friction between the following vehicle FC travelling on this road surface and the road surface may be assumed to be substantially the same as this calculated coefficient of friction, and the above-described coefficient of friction may be set. The rear-end collision possibility determination unit 10D can extract, from the memory MD or the like, the coefficient of friction with the road surface based on the road surface condition determined by the road surface condition determination unit 10B.

As for the vehicle weight Mb of the following vehicle FC, for example, a determination as to whether the vehicle is a large or non-large vehicle may be made via the image capturing sensor SR₁ to use the weight assumed for the large or non-large vehicle, vehicle weight information may be obtained from the following vehicle FC through vehicle-to-vehicle communication, or a vehicle image captured by the image capturing sensor SR₁ may be checked against a known vehicle database installed inside or outside the vehicle to identify the corresponding vehicle type and weight.

Under the above assumption, in this embodiment, the velocity at which the distance between vehicles is smaller than the braking distance of the following vehicle FC is used as a condition for initiating braking. At this time, in the following vehicle FC, the conservation of energy expressed by Expression (1) below holds.

$$\frac{1}{2} {M}_{b} {v}_{b}^{2} = {M}_{b} g μ {L}_{b} \qquad ( 1 )$$

Furthermore, the braking distance L_{b} of the following vehicle FC at the vehicle velocity V_{b} is given by “L_{b}=V_{b}²/2gμ”. Assuming that the time taken for the following vehicle FC to travel the braking distance L_{b} and rear-end the vehicle is t, “t=V_{b}/2gμ”. The distance Vat the vehicle 200 travels while the following vehicle FC is traveling during the time t is given by “Vₐt=VₐV_{b}/2gμ”. Thus, when L_{ab} satisfies a condition expressed by Expression (2) below, damping force control according to this embodiment can be initiated.

$${L}_{ab} < {L}_{b} - {v}_{a} t = \frac{{v}_{b}^{2}}{2 g μ} - \frac{{v}_{a} {v}_{b}}{2 g μ} = \frac{{v}_{b} ( {v}_{b} - {v}_{a} )}{2 g μ} \qquad ( 2 )$$

The rear-end collision possibility determination unit 10D according to this embodiment determines, based on the above-described condition for initiating braking, that the following vehicle FC is to rear-end the vehicle with relatively large energy when the distance L_{ab} to the following vehicle FC traveling at the vehicle velocity V_{b} satisfies a first condition (emergency rear-end collision condition) expressed by Expression (3) below. Furthermore, “N” in Expression (3) is a constant and may be specified as about “2” in this embodiment, but may also be set to an appropriate value through experiment or simulation.

$$\frac{{v}_{b} ( {v}_{b} - {v}_{a} )}{2 g μ} > {NL}_{ab} \qquad ( 3 )$$

Further, the rear-end collision possibility determination unit 10D according to this embodiment determines, based on the above-described condition for initiating braking, that the following vehicle FC is to rear-end the vehicle with normally expected energy when the distance L_{ab} to the following vehicle FC traveling at the vehicle velocity V_{b} satisfies a second condition (normal rear-end collision condition) expressed by Expression (4) below.

$$\frac{{v}_{b} ( {v}_{b} - {v}_{a} )}{2 g μ} > {L}_{ab} \qquad ( 4 )$$

Thus, the rear-end collision possibility determination unit 10D according to this embodiment can determine, based on the distance L_{ab} to the following vehicle FC traveling at the vehicle velocity V_{b} and vehicle velocity information (Vₐ and V_{b}) of the vehicle 200 and the following vehicle, the possibility of a rear-end collision with the following vehicle FC. Although the anti-lock braking system (ABS) is not considered in this embodiment, conditions may be set in consideration of braking assistance provided by the ABS instead.

Furthermore, the rear-end collision possibility determination unit 10D may use, in addition to the technique described above, other known techniques, such as determining the possibility of a rear-end collision with the following vehicle FC from information detected by a millimeter-wave radar disclosed in JP-A No. 2010-201951, for example.

### (Damper Controller 10E)

The damper controller 10E has a function of adjusting the damping force of the dampers in the above-described electronically controlled suspensions 6 installed in the vehicle 200 based on a result of a determination made by the rear-end collision possibility determination unit 10D described above.

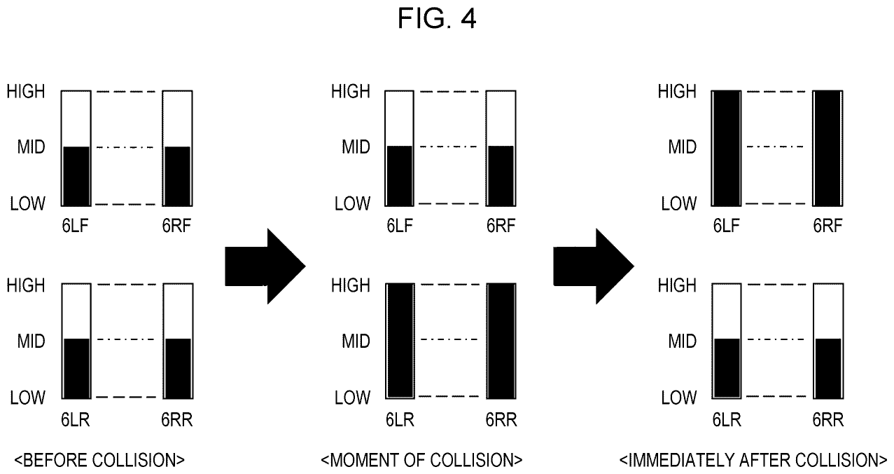

In one example, as illustrated in FIG. 4, when it is determined that a rear-end collision by the following vehicle FC is to occur, the damper controller 10E according to this embodiment primarily performs a process of increasing the damping force of the dampers in the rear electronically controlled suspensions (6LR and 6RR) compared with the damping force of the dampers in the front electronically controlled suspensions (6LF and 6RF) at the moment of the collision with the following vehicle FC. Furthermore, as illustrated in FIG. 4, the damper controller 10E according to this embodiment secondarily performs a process of increasing the damping force of the dampers in the front electronically controlled suspensions (6LF and 6RF) compared with the damping force of the dampers in the rear electronically controlled suspensions (6LR and 6RR) immediately after the collision with the following vehicle FC.

As described above, the damper controller 10E can perform the process of relatively increasing the damping force of the rear dampers at the moment of the collision with the following vehicle FC, whereas the damper controller 10E can perform the process of relatively increasing the damping force of the front dampers immediately after the collision following the moment of the collision with the following vehicle FC. This makes it possible to firstly suppress changes in the attitude of the vehicle at the moment of the rear-end collision so that occupants can be securely supported in their seats and to stabilize the pitch behavior of the vehicle immediately after the collision to contribute to improved brake braking force, for example.

Although the damper controller 10E according to this embodiment adjusts the damping force of the dampers in the electronically controlled suspensions 6 in three levels (Low, Mid, and High) as illustrated in FIG. 4, the damper controller 10E may use any other damping force values, may adjust the damping force of the dampers in the electronically controlled suspensions 6 in two levels, or may adjust the damping force as described above in four or more levels.

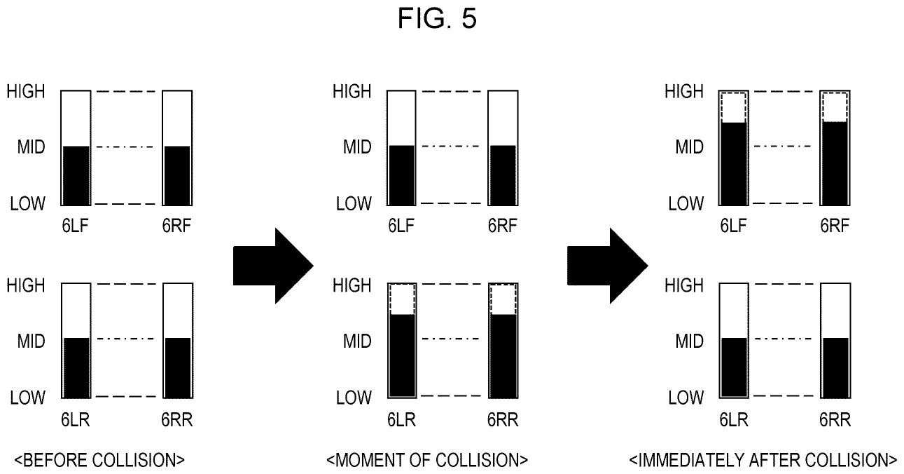

Furthermore, the damper controller 10E may vary the damping force of the dampers in the electronically controlled suspensions 6 based on the road surface condition determined by the road surface condition determination unit 10B described above. That is, the above-described memory MD can store road surface condition data (dry, wet, frozen, etc.) obtained in determining the coefficient of friction with the road surface as described above. Thus, as illustrated in FIG. 5 as an example, when the road surface is frozen, the damper controller 10E may set the damping force of the dampers in the electronically controlled suspensions 6 to a value different from that during dry conditions (for example, a value intermediate between Mid and High) without raising the damping force of the dampers from Mid to High. In this example, the adjustment range of the damping force during road surface freezing is smaller than the adjustment range of the damping force during dry conditions, but the adjustment range may be made further appropriate through experiment or simulation.

As described above, when it is determined that a rear-end collision by the following vehicle FC is to occur, the damper controller 10E may vary an increase in the damping force in the dampers according to the road surface condition data (dry, wet, etc.) described above. Although, in this embodiment, three conditions: dry, wet, and frozen are given as an example of the road surface condition data, other known road surface conditions, such as “snowfall (SNOW)” may also be added.

### (Notification Controller 10F)

The notification controller 10F has a function of notifying an occupant of various situations during a rear-end collision caused by the following vehicle FC. For example, when the rear-end collision possibility determination unit 10D determines that a rear-end collision by the following vehicle FC is to occur, the notification controller 10F according to this embodiment may notify an occupant of a warning through the notification devices PD including the speaker SP and the display DP, which are described above. The notification controller 10F may also couple to an external terminal, such as a smartphone carried by the occupant, to notify the occupant of the warning.

### <Suspension Control Method>

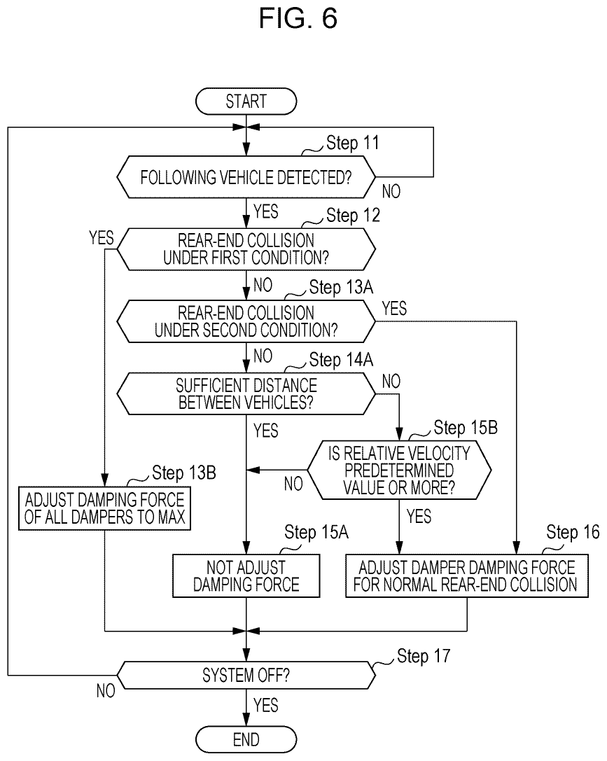

Next, a suspension control method according to this embodiment will be described with reference to FIG. 6. Such a suspension control method may be used as an algorithm of a program (suspension control program) executable by the above-described control device 10. The program having such an algorithm can be distributed, for example, such that the program can be downloaded into the control device 10 via a known network, or can be distributed with the program stored in a recording medium.

First, in Step 11, it is determined whether a following vehicle traveling behind the vehicle 200 has been detected. In one example, the following vehicle detector 10A of the control device 10 detects the presence/absence of the following vehicle FC within a lane in which the vehicle 200 travels, for example, via the in-vehicle sensors SR (image capturing sensor SR₁). When the following vehicle FC is not detected in Step 11 (No in Step 11), the processing of Step 11 is repeated again. On the other hand, when the following vehicle FC is detected in Step 11 (Yes in Step 11), the method proceeds to Step 12.

In the subsequent Step 12, it is determined whether the following vehicle FC satisfies the first condition described above and is to rear-end the vehicle 200. In one example, the rear-end collision possibility determination unit 10D of the control device 10 determines in Step 12 whether the state of the vehicle 200 and the following vehicle FC satisfies the condition expressed by Expression (3) described above.

When it is determined in Step 12 that the first condition described above is satisfied and a rear-end collision is to occur (Yes in Step 12), it is likely that the following vehicle FC is to collide with the vehicle 200 with relatively large energy. In this case, the method proceeds to Step 13B, and the damper controller 10E of the control device 10 performs control to adjust the damping force of the dampers in all the electronically controlled suspensions 6 (6LF, 6RF, 6LR, and 6RR) to a maximum value (Max). Thus, collision energy can be absorbed by all the electronically controlled suspensions, making it possible to stabilize the behavior of the vehicle during a rear-end collision to contribute to improved brake braking force, for example.

When it is determined in Step 12 that the first condition described above is not satisfied and a rear-end collision is not to occur (No in Step 12), it is determined in the subsequent Step 13A whether the following vehicle FC satisfies the second condition described above and is to rear-end the vehicle 200. In one example, the rear-end collision possibility determination unit 10D of the control device 10 determines in Step 13A whether the state of the vehicle 200 and the following vehicle FC satisfies the condition expressed by Expression (4) described above. When it is determined in Step 13A that the second condition described above is satisfied and a rear-end collision is to occur (Yes in Step 13A), it is likely that the following vehicle FC is to collide with the vehicle 200 with normally expected energy. In this case, the method proceeds to Step 16, and the damper controller 10E of the control device 10 performs damping force adjustment for the dampers in the electronically controlled suspensions 6 illustrated in FIG. 4, for example.

That is, for example, the damper controller 10E performs a process of increasing the damping force of the rear dampers compared with that of the front dampers at the moment of the collision with the following vehicle FC, whereas the damper controller 10E performs a process of reversing the distribution of damping force to increase the damping force of the front dampers compared with that of the rear dampers immediately after the collision with the following vehicle FC. Thus, while occupants are stably held in their seats, a stable vehicle behavior during a rear-end collision can be achieved to improve brake braking force.

On the other hand, when it is determined in Step 13A that the second condition described above is not satisfied and a rear-end collision is not to occur (No in Step 13A), the method proceeds to Step 14A, and it is determined whether there is a sufficient distance between the vehicle 200 and the following vehicle FC. In one example, the following vehicle detector 10A of the control device 10 detects a distance between the vehicle 200 and the following vehicle FC, for example, via the in-vehicle sensors SR (distance measuring sensor SR₂). The sufficient distance between vehicles described above may be set to any value (for example, 2 m), for example, in accordance with a vehicle velocity at which a rear-end collision is expected, or may be set in advance through experiment or simulation.

When it is determined in Step 14A that the above-described distance between vehicles is sufficient (Yes in Step 14A), it is likely that there is a high possibility that the following vehicle FC is not to rear-end the vehicle 200. In this case, the damper controller 10E of the control device 10 does not perform the damping force adjustment for the dampers in the electronically controlled suspensions 6 described above and performs control to maintain default (normal) state settings, for example.

On the other hand, when it is determined in Step 14A that the above-described distance between vehicles is not sufficient (No in Step 14A), it is likely that the possibility that the following vehicle FC is to rear-end the vehicle 200 remains. In this case, the control device 10 proceeds to Step 15B to determine whether a relative velocity between the vehicle 200 and the following vehicle FC is a predetermined value or more.

In one example, the following vehicle detector 10A of the control device 10 detects a relative velocity between the vehicle 200 and the following vehicle FC, for example, via the in-vehicle sensors SR (distance measuring sensor SR₂ and vehicle state sensor SR₃). The “predetermined value” described above may be set to any value, such as “15 km/h”, or may be set in advance through experiment or simulation.

When it is determined in Step 15B that the above-described relative velocity is not the predetermined value or more (No in Step 15B), it is likely that the following vehicle FC is to collide with the vehicle 200 at a relatively slow velocity even when a rear-end collision occurs. In this case, the damper controller 10E of the control device 10 does not perform the damping force adjustment for the dampers in the electronically controlled suspensions 6 described above and performs control to maintain default (normal) state settings, for example.

On the other hand, when it is determined in Step 15B that the above-described relative velocity is the predetermined value or more (Yes in Step 15B), it is likely that the following vehicle FC is to collide with the vehicle 200 with normally expected energy. In this case, the method proceeds to Step 16 described above, and the damper controller 10E of the control device 10 can perform damping force adjustment for the dampers in the electronically controlled suspensions 6 illustrated in FIG. 4, for example.

The method proceeds to Step 17 through Step 13B, Step 15A, or Step 16. When a system of the vehicle 200 is not OFF, the method may return to Step 11 to perform the above-described processing again.

In the suspension control apparatus and the control method according to this embodiment described above, the damping force of the dampers in the electronically controlled suspensions can be adjusted in accordance with the pattern of a rear-end collision (such as a collision with large energy) with the following vehicle FC, and thus a stable vehicle behavior is achieved. Furthermore, in the suspension control apparatus and the control method according to this embodiment, the damping force of the dampers in the electronically controlled suspensions can be varied at the moment of and immediately after a rear-end collision, and thus a more stable vehicle behavior is achieved during the rear-end collision.

### Second Embodiment

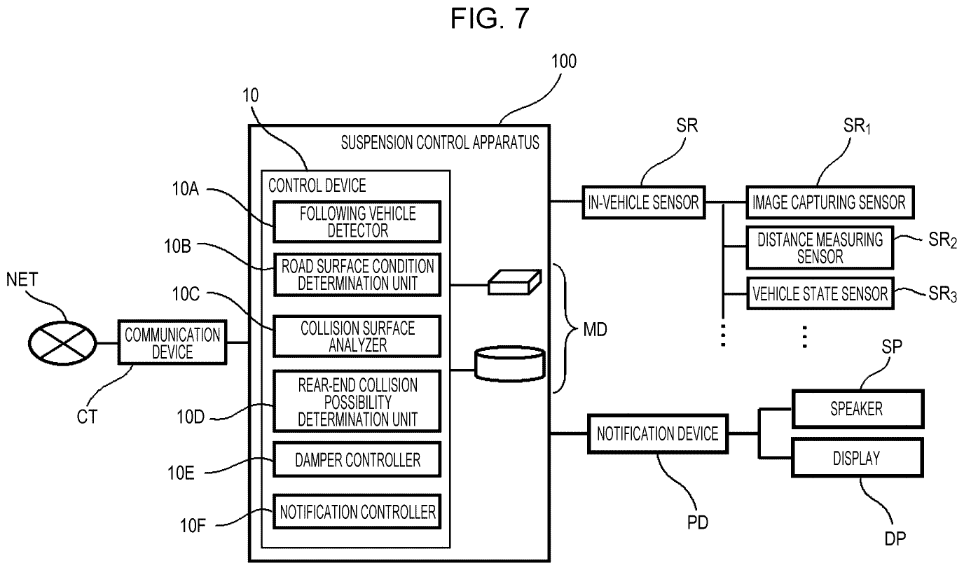

Next, a second embodiment of the disclosure will be described with reference to FIGS. 7 to 10. In this embodiment, components that are the same as those described in the first embodiment are denoted by the same reference numerals, and thus a repeated description thereof is omitted as appropriate.

FIG. 7 illustrates an example configuration of the suspension control apparatus 100 and its peripheral devices according to this embodiment. In comparison with the first embodiment described above, the control device 10 according to this embodiment further includes a collision surface analyzer 10C.

### (Collision Surface Analyzer 10C)

The collision surface analyzer 10C has a function of analyzing at which part of the following vehicle FC a rear-end collision with the rear end of the vehicle 200 is to occur. The collision surface analyzer 10C detects collision surface characteristic data including a collision point CP (see FIG. 2) of the following vehicle FC, for example, via the in-vehicle sensors SR (image capturing sensor SR₁ and distance measuring sensor SR₂) installed in the rear area of the vehicle. Here, the “collision point CP” of the following vehicle FC refers to a part projecting most toward the tip of the following vehicle (toward the front of the vehicle) and can be defined as a highly probable collision part that first comes into contact with some obstacle ahead (the vehicle 200 in this example) when colliding with it.

As an example, when the image capturing sensor SR₁ refers to stereo cameras disposed at the rear of the vehicle, the collision surface analyzer 10C can generate the collision surface characteristic data by analyzing the collision surface shape of the following vehicle FC using artificial intelligence (AI) image analysis, for example. As another example, when a known 3D-LiDAR sensor is installed in the rear area of the vehicle as the distance measuring sensor SR₂, the collision surface analyzer 10C may generate the collision surface characteristic data by analyzing the three-dimensional shape of the following vehicle FC using the 3D-LiDAR sensor.

The above-described analyses of the shape of the following vehicle FC are examples. The collision surface analyzer 10C may analyze the collision surface shape of the following vehicle FC by performing a vehicle type checking process using following-vehicle image data illustrated in JP-A No. 2009-77459, for example.

The above-described memory MD can store the collision surface characteristic data on the collision surface of the following vehicle FC (for example, the front surface shape of the following vehicle FC including the collision point CP) analyzed by the collision surface analyzer 10C. The rear-end collision possibility determination unit 10D according to this embodiment detects a height above the ground at the collision point CP analyzed by the collision surface analyzer 10C and compares a center-of-gravity height H1 of the vehicle 200 with a collision position height H2 of the collision surface of the following vehicle FC (that is, the height above the ground at the collision point CP).

For example, when the height of the collision surface (the height above the ground at the collision point CP) is higher than the center-of-gravity height of the vehicle 200, such as when the vehicle is a sedan and the following vehicle is a sport-utility vehicle (SUV), it is likely that the following vehicle FC is to collide with the vehicle 200 with relatively large energy so as to ride up onto the vehicle 200. Hence, when the height of the collision surface (the height above the ground at the collision point CP) is higher than the center-of-gravity height of the vehicle 200, the damper controller 10E may perform control to adjust the damping force of the dampers in all the electronically controlled suspensions 6 (6LF, 6RF, 6LR, and 6RR) to a maximum value (Max).

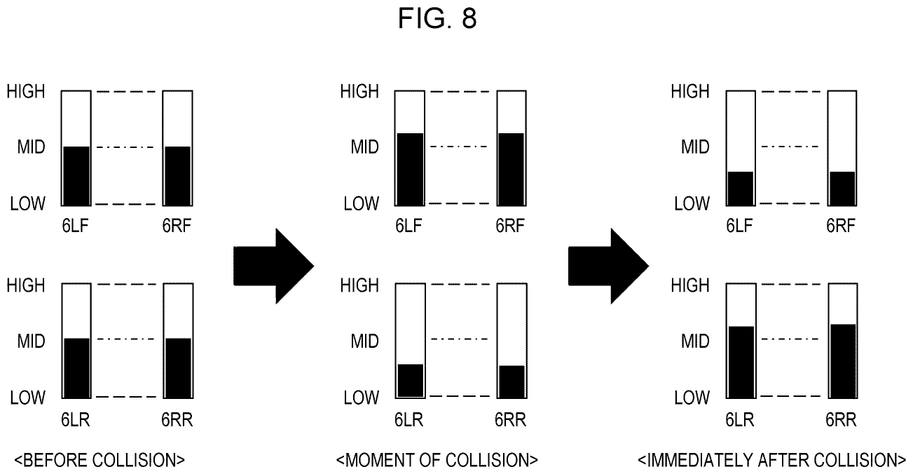

As illustrated in FIG. 8, when the height of the collision surface (the height above the ground at the collision point CP) is higher than the center-of-gravity height of the vehicle 200, the damper controller 10E can perform, in place of the process of adjusting the damping force of the dampers in all the electronically controlled suspensions to the maximum value, a process of increasing the damping force of the front dampers compared with the damping force of the rear dampers at the moment of the collision described above. In this case, the damper controller 10E increases the damping force of the front dampers compared with that of the rear dampers at the moment of the collision with the following vehicle FC, whereas the damper controller 10E performs a process of reversing the distribution of damping force to increase the damping force of the rear dampers compared with that of the front dampers immediately after the collision with the following vehicle FC.

### <Suspension Control Method>

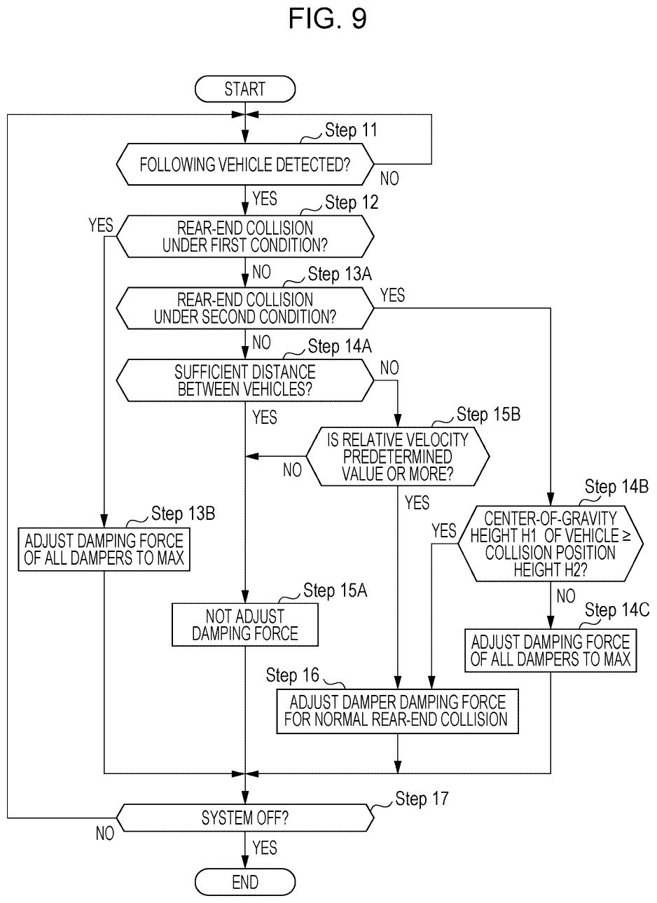

Next, a suspension control method according to the second embodiment will be described with reference to FIG. 9, omitting steps similar to those in the first embodiment as appropriate.

In this embodiment, when it is determined in Step 13A that the second condition described above is satisfied and a rear-end collision is to occur (Yes in Step 13A), the method proceeds to Step 14B.

The rear-end collision possibility determination unit 10D of the control device 10 determines in Step 14B whether the center-of-gravity height H1 of the vehicle 200 is higher than or equal to the collision position height H2 of the following vehicle (the height above the ground at the collision point CP). In Step 14B, when the center-of-gravity height H1 described above is higher than or equal to the collision position height H2, the method proceeds to Step 16, and the damper controller 10E performs the damper damping force adjustment for a normal rear-end collision described above.

On the other hand, in Step 14B, when the center-of-gravity height H1 described above is less than the collision position height H2, the method proceeds to Step 14C, and the damper controller 10E adjusts the damping force of the dampers in all the electronically controlled suspensions 6 (6LF, 6RF, 6LR, and 6RR) to the maximum value (Max). As described above, in Step 14C, the damper controller 10E may increase the damping force of the front dampers compared with that of the rear dampers at the moment of the collision with the following vehicle FC, whereas the damper controller 10E may perform the process of increasing the damping force of the rear dampers compared with that of the front dampers immediately after the collision with the following vehicle FC.

The suspension control apparatus and the control method according to the second embodiment described above enable, in addition to the above-described effects of the first embodiment, more appropriate damping force adjustment for the electronically controlled suspensions when a rear-end collision occurs, taking into consideration, for example, differences in the type of vehicle between the vehicle and the following vehicle.

Although the embodiments of the disclosure have been described above in detail with reference to the attached drawings, the disclosure is not limited to such examples. It is apparent to those skilled in the art to which the disclosure pertains that further changes to these embodiments or modifications are attempted within the scope of the technical idea described in the claims. It is to be understood that these changes are also naturally within the technical scope of the disclosure.

For example, although, in the embodiment described above, the collision surface analyzer 10C analyzes the height above the ground at the collision point CP of the following vehicle FC as the collision surface characteristic data, the collision surface analyzer 10C may analyze a position in a width direction at the collision point CP as the collision surface characteristic data. That is, the collision surface analyzer 10C may determine which part of the vehicle 200 in the vehicle width direction the following vehicle FC may collide with.

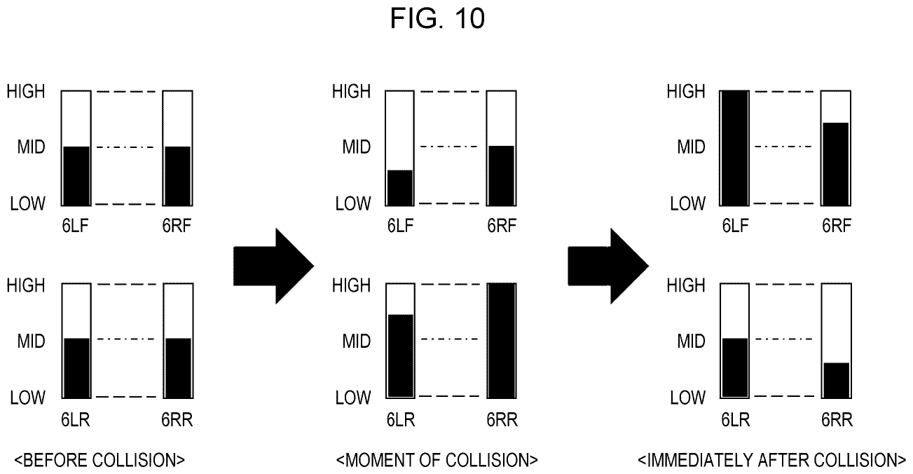

In other words, as illustrated in FIG. 10, when it is determined that a rear-end collision by the following vehicle FC is to occur, the collision surface analyzer 10C may determine a collision part PC in the vehicle width direction of the vehicle 200 with the following vehicle FC, and the damper controller 10E may make the damping force of a right-wheel damper and the damping force of a left-wheel damper different from each other according to the position of the collision part PC in the vehicle width direction. Although FIG. 10 illustrates an example based on the damper damping force adjustment for a normal rear-end collision in Step 16 in which the collision part PC is on the right in the vehicle width direction, the manner of damping force adjustment may be more precisely set through experiment or simulation.

The suspension control device according to the disclosure can achieve a more stable vehicle behavior during the rear-end collision.

The control device 10 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 10 including the following vehicle detector 10A, the rear-end collision possibility determination unit 10D, the damper controller 10E, and the notification controller 10F. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. A suspension control apparatus configured to be applied to a vehicle and switch damping force characteristics of a damper in an electronically controlled suspension, the suspension control apparatus comprising:
a memory configured to store following-vehicle data from an in-vehicle sensor configured to measure a distance between a following vehicle rushing from behind and the vehicle; and
a control device configured to
determine, based on the following-vehicle data stored in the memory, whether a rear-end collision between the following vehicle and the vehicle is to occur,
when determining that the rear-end collision is to occur, perform a process of increasing a damping force of a rear damper disposed on a rear-wheel side of the vehicle compared with a damping force of a front damper disposed on a front-wheel side of the vehicle.

2. The suspension control apparatus according to claim 1,
wherein the memory is configured to further store data on a condition of a road surface on which the vehicle travels, and
wherein the control device is configured to, when determining that the rear-end collision is to occur, vary an increase in a damping force in the damper according to the data on the condition of the road surface.

3. The suspension control apparatus according to claim 1,
wherein the memory is configured to further store collision surface characteristic data on a collision surface of the following vehicle when the following vehicle is to collide with the vehicle, and
wherein the control device is configured to
when determining that the rear-end collision is to occur, compare a center-of-gravity height of the vehicle with a height of the collision surface of the following vehicle, and
when the height of the collision surface is higher than the center-of-gravity height of the vehicle, increase the damping force of the front damper compared with the damping force of the rear damper in place of the process of increasing the damping force of the rear damper.

4. The suspension control apparatus according to claim 2,
wherein the memory is configured to further store collision surface characteristic data on a collision surface of the following vehicle when the following vehicle is to collide with the vehicle, and
wherein the control device is configured to
when determining that the rear-end collision is to occur, compare a center-of-gravity height of the vehicle with a height of the collision surface of the following vehicle, and
when the height of the collision surface is higher than the center-of-gravity height of the vehicle, increase the damping force of the front damper compared with the damping force of the rear damper in place of the process of increasing the damping force of the rear damper.

5. The suspension control apparatus according to claim 3,
wherein the control device is configured to, when determining that the rear-end collision is to occur, determine a collision part in a vehicle width direction of the vehicle with the following vehicle and make a damping force of a right-wheel damper and a damping force of a left-wheel damper different from each other according to the collision part.

6. The suspension control apparatus according to claim 4,
wherein the control device is configured to, when determining that the rear-end collision is to occur, determine a collision part in a vehicle width direction of the vehicle with the following vehicle and make a damping force of a right-wheel damper and a damping force of a left-wheel damper different from each other according to the collision part.

7. A vehicle comprising:
the in-vehicle sensor; and
the suspension control apparatus according to claim 1.

8. A suspension control apparatus configured to be applied to a vehicle and switch damping force characteristics of a damper in an electronically controlled suspension, the suspension control apparatus comprising:
a memory configured to store following-vehicle data from an in-vehicle sensor configured to measure a distance between a following vehicle rushing from behind and the vehicle; and
circuitry configured to
determine, based on the following-vehicle data stored in the memory, whether a rear-end collision between the following vehicle and the vehicle is to occur, and
when determining that the rear-end collision is to occur, perform a process of increasing a damping force of a rear damper disposed on a rear-wheel side of the vehicle compared with a damping force of a front damper disposed on a front-wheel side of the vehicle.
